(19) United States
(12) Patent Application Publication
(10) Pub. No.: US 2008/0178040 A1
(43) Pub. Date: Jul. 24, 2008

(54) Disk failure restoration method and disk array apparatus

(75) Inventor: Tatsuya Kobayashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/979,738

(22) Filed: Nov. 7, 2007

Related U.S. Application Data
(63) Continuation of application No. PCT/JP2005/009188, filed on May 19, 2005.

(51) Int. Cl. G06F 11/20

(52) U.S. Cl. 714/6; 714/E11.084

(57) ABSTRACT

If a disk fails, another disk is used to rebuild the data of the failed disk on a first spare disk. When finishing being rebuilt, the first spare disk is separated from the disk array apparatus. Data to be updated while the first spare disk separated is written in another disk and managed by a bit map. The first spare disk is connected to the disk array apparatus at the position of the failed disk, then only the updated data is rebuilt on the first spare disk using another disk.

### CROSS REFERENCE TO RELATED APPLICATION

This application is a continuation application and is based upon PCT/JP2005/009188, filed on May 19, 2005.

### BACKGROUND OF THE INVENTION

1. Field of the Invention

The present invention relates to a method of restoration from failure of a disk in a disk array apparatus.

2. Description of the Related Art

A disk array comprised of a large number of storage disks connected to a network server disperses data among a plurality of hard disks, that is, magnetic disk apparatuses, so as to simultaneously secure performance and tolerance against trouble. It is also known as a “redundant array of independent disks” (RAID).

RAID is technology for managing hard disks. It is classified into several levels according to the method of allocation of data to the magnetic disks or the data redundancy, that is, the method of multiplexing. RAID, for example, includes the following levels:

RAID0 divides data into block units and records the data dispersed over a plurality of disks. Since the data is arranged in stripes spanning several disks, this is also called “striping”. Since the dispersed data can be simultaneously accessed in parallel, access becomes high in speed.

RAID1 simultaneously writes data into two disks and is also called “mirroring”. The access speed is not improved, but data is never lost and the system does not come to a stop due a disk failure.

RAID0+1 uses at least four disks and is a combination of RAID0 and RAID1. It can realize both the duplexing of data by RAID1 and the higher speed of RAID0.

RAID4 adds a dedicated disk storing parity data to the striping of RAID0 so as to give the function of regenerating data.

RAID5 arranges parity data dispersed over all of the disks so as to avoid the concentration of input and output at the parity disk in RAID4.

Taking as an example RAID1, the method of restoration conventionally employed when a disk failure occurred will be explained with reference to FIG. 1. A RAID1 pair comprised of a disk A1 and disk A2 store the same data. If for example the disk A1 of the RAID1 pair, the data is copied from the disk A2 to a spare disk, that is, a hot spare B (FIG. 1(a)). The failed disk A1 is replaced with a new disk A1′, then the data is transferred to the new disk A1′ from the spare disk B to which the data was previously transferred (FIG. 1(b)). As a result, the disks A1′ and A2 become the RAID1 pair (FIG. 1(c)).

However, in the conventional processing, the data is copied twice (from the disk A2 to the disk B and from the disk B to the disk A1′), so the processing ends up taking time. Further, in recent years, the storage capacities of the hard disks mounted in disk array apparatuses have become greater, for example, reaching a capacity of 300 GB for a 3.5 inch hard disk. Therefore, the processing time for transferring the large amount of data also increases. Further, during transfer of data, the response for input and output to and from the host drops and the danger of double failure increases. Therefore, even shorter transfer of data than in the past is being sought.

To shorten the processing time at the time of a failure in a hard disk, it has been proposed to set the disk A2 and the disk B as the RAID pair when finishing transferring data to the spare disk B (see Japanese Patent Publication (A) No. 3-111928). However, the physical positions of the disks forming a RAID pair will end up shifting, so it will become difficult to determine later which disks are paired and therefore there will be a problem in management. Note that it has been proposed that when a failure occurs, a maintenance worker connect a maintenance magnetic disk to the system and replace the failed disk with this maintenance magnetic disk (see Japanese Patent Publication (A) No. 9-282106), but when copying data from a failed disk to a maintenance magnetic disk and detecting an error at the time of copying, that data is copied from a not failed disk by referring to the logic volume number and duplexing information.

### SUMMARY OF THE INVENTION

An object of the present invention, in consideration of the above problem, is to provide a method of restoration from failure of a disk of a disk array apparatus which can shorten the processing time for reconfiguring a RAID without changing the positions of the disks in the RAID.

To solve the above problems, according to a first aspect of the present invention, there is provided a method for restoring a disk array apparatus from failure of a disk, comprising rebuilding data from another disk at a first spare disk, separating the rebuilt first spare disk from the disk array apparatus, writing data to be updated in said separated first space disk into the other disk until the separated first spare disk is connected with the disk array apparatus and storing the disk region of said data to be updated into a bit map, and connecting the rebuilt first spare disk to the disk array apparatus at the position of arrangement of the failed disk.

Further, the method may also comprise, after connecting the first spare disk to the disk array apparatus, rebuilding the updated data from the other disk on the first spare disk by referring to the bit map.

Further, the method may further comprise, when writing the data to be updated in the other disk, rebuilding the updated data written in the other disk on a second spare disk.

Further, the method may further comprise, when the other disk fails, connecting the first spare disk to the disk array apparatus, then rebuilding the updated data from the second spare disk at the first spare disk by referring to the bit map.

According to a second aspect of the present invention, there is provided a disk array apparatus comprising a redundant disk array, a first spare disk storing rebuilt data of a failed disk in the redundant disk array using data of another disk, and a bit map storing a region of the first spare disk in which data is to be updated in the first spare disk when a first spare disk is detached from the apparatus.

The present invention can shorten the processing time for reconfiguring a RAID without changing the positions of the disks in the RAID.

### BRIEF DESCRIPTION OF THE DRAWINGS

These and other objects and features of the present invention will become clearer from the following description of the preferred embodiments given with reference to the attached drawings, wherein:

FIG. 1 is a view showing a conventional method of restoration from disk failure;

FIG. 2 is a view showing a disk array system for carrying out the present invention;

FIG. 3 is a view showing the flow of the operation of an embodiment of the present invention;

FIG. 4 is a view showing an embodiment of application of the present invention to RAID1;

FIG. 5 is a view showing an embodiment of application of the present invention to RAID5.

### DESCRIPTION OF THE PREFERRED EMBODIMENTS

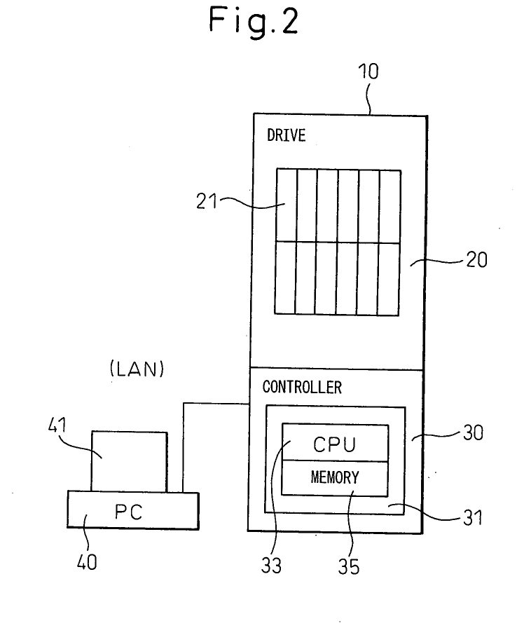

A disk array apparatus (RAID) has a housing storing a large number of hard disks in a detachable manner and allows a failed disk to be taken out from the housing and replaced. FIG. 2 shows an example of a disk array system including a disk array apparatus to which the present invention is applied.

A disk array apparatus 10 is comprised of a drive enclosure 20 containing a large number of disks 21 such as magnetic disks in an interchangeable manner and a controller enclosure 30 containing a controller module 31 controlling the disks. The controller module 31 is formed by a board provided with a CPU 32 and a memory 34. Further, a maintenance terminal 40 connected to a local are a network (LAN) is provided. The maintenance terminal 40 is comprised of a general personal computer (PC) which can show graphs for maintenance and inspection of the disk array on its display 41 and enables various operations by clicking on the displayed operation buttons. For example, the disks can be separated from the disk array apparatus and replaced. Further, the display 41 can show the position of a failed disk by for example the red color. When replacing a failed disk, at the instruction from the maintenance terminal, the failed disk is separated from the disk array apparatus and replaced manually by the operator.

An embodiment of the present invention relates to the method of restoration from a failure in a certain disk in the disk array system such as shown in FIG. 2.

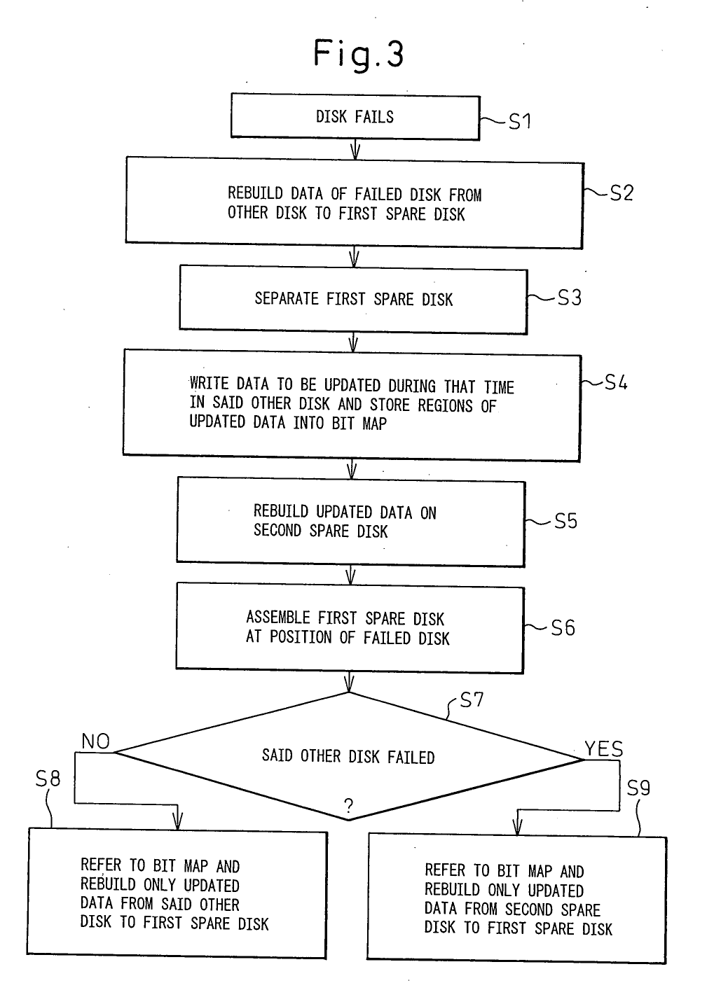

FIG. 3 shows the flow of an embodiment of the present invention. If a failure occurs in one disk forming the RAID at step S1, at step S2, data of another disk forming the RAID is used to rebuild the data of the failed disk in a first spare disk. For example, in the RAID1, the data of the other disk is copied to the first spare disk. Further, in the RAID5, the data of the other plurality of disks and parity data are used to rebuild the data of the failed disk in the first spare disk.

At step S3, when the data finishes being rebuilt in the first spare disk, the first spare disk is separated from the disk array apparatus.

If there is data to be updated in the first spare disk while the first spare disk is separated, at step S4, the data to be updated is written into another disk and the regions of the data to be updated are stored into a bitmap and managed by the bit map. After this, at step S5, the updated data written in the other disk is further rebuilt in a second spare disk.

At step S6, the first spare disk is used to replace the failed disk and is assembled in the disk array apparatus at the position where the failed disk had been placed.

At step S7, it is judged if the other disk has failed. If the other disk is normal, at step S8, the other disk is used and the bit map referred to so as to rebuild only the updated data in the assembled first spare disk. If it is judged at step S7 that the other disk is abnormal, at step S9, the second spare disk is used and the bit map referred to so as to rebuild only the updated data in the first spare disk.

By doing this, it is possible to restore the system from a failed disk in a short time without changing the arrangement of disks in the RAID.

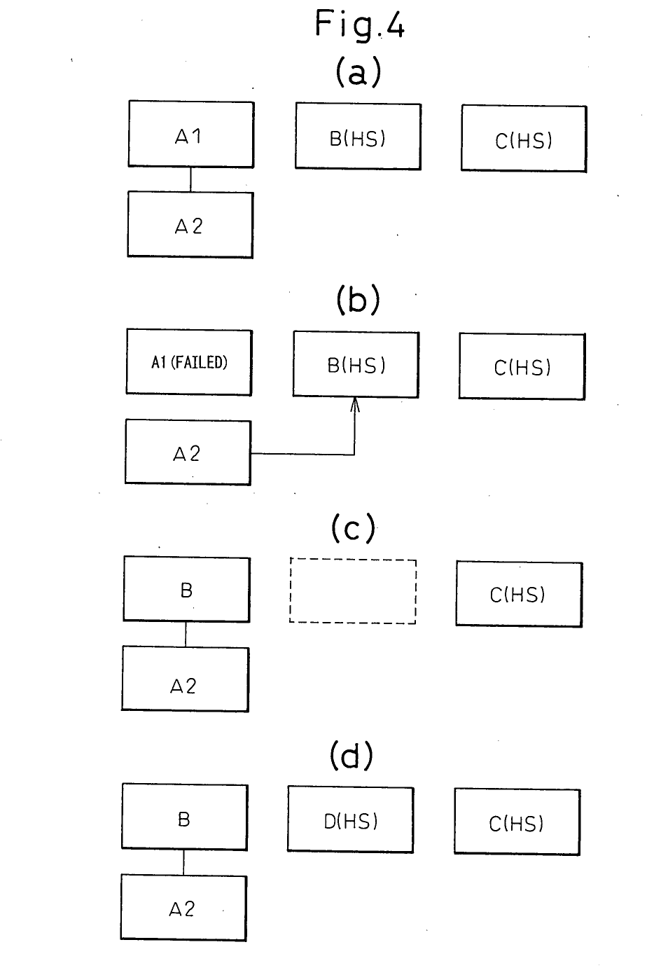

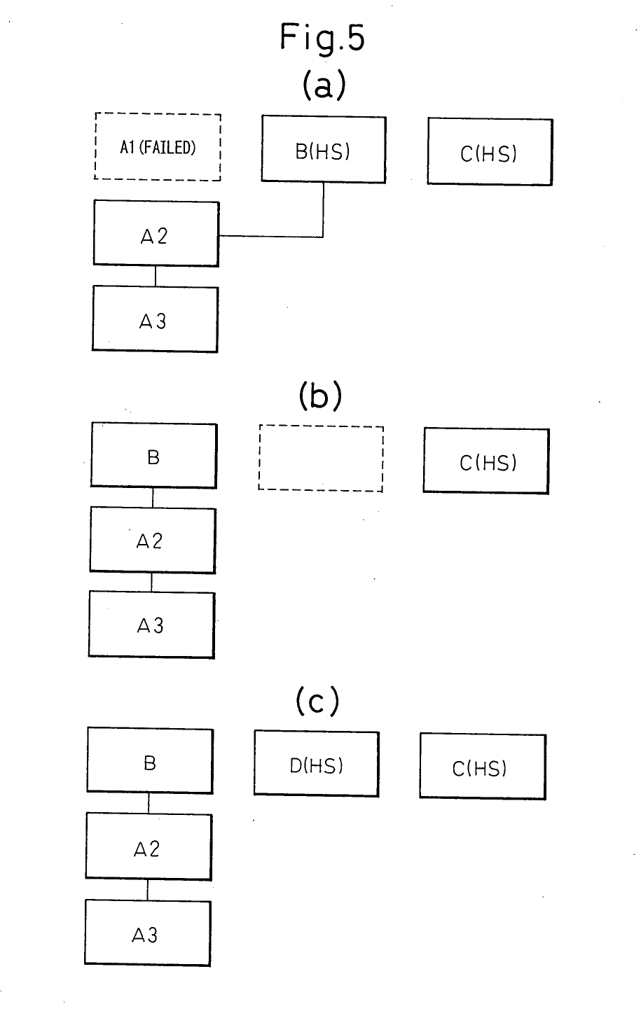

Below, referring to FIGS. 4 and 5, embodiments of application of the present invention to the RAID1 and 5 will be explained.

FIG. 4 schematically shows a first embodiment of application to the RAID1. Among the large number of pairs of hard disks forming the RAID1, the disks A1 and A2 are shown. As spare disks, that is, hot spares, the disks B and C are shown.

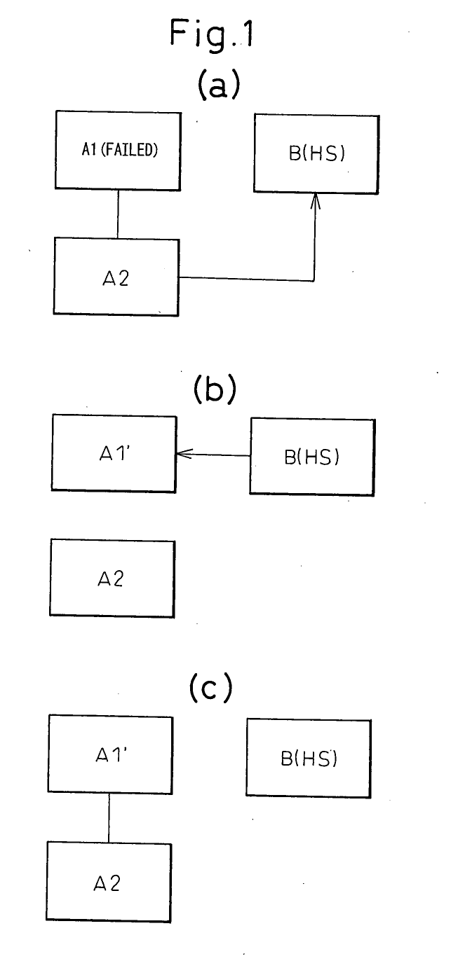

As shown in FIG. 4(a), before a failure occurs, the disk A1 and disk A2 form a RAID1 pair and the two have the same data written in them. If the disk A1 fails, as shown in FIG. 1(b), data is copied to the spare disk B from the normal disk A2 for the transfer of data. When the transfer of data finishes, the data is duplexed by the disk A2 and disk B and the RAID1 redundancy is rebuilt. This work is generally called “rebuilding”, but in the RAID1, the data is only copied to a spare disk.

Next, copyback processing for restoring the original state is performed. In the present embodiment, the disk B to which data has finished being transferred is physically moved to the position where the disk A1 had been inserted and is inserted there in place of the disk A1 (FIG. 4(c)). By doing this, the physical positions of the disks forming the RAID do not have to be changed. Further, since it is not necessary to use a new disk A1′ and copy data from the disk B, the time can be shortened.

However, in the copyback processing of the present embodiment, the disk B is separated from the disk array apparatus once, so even if there is updated data to be input to the disk B before the separated disk B is assembled at the position where the disk A1 had been, the updated data cannot be written into the disk B. Therefore, simultaneously with when the disk B is separated from the disk array apparatus, bit map management of the updated data and use of the spare disk C are started.

A “bit map” is a table for management of updated regions of a disk stored in a memory 35 provided in a controller module 31 of the disk array apparatus 10 of FIG. 2. In a bit map, a disk as a whole is divided into regions of a predetermined size (for example, 8 kbytes). If data is updated in even part of a region, the entire region of that predetermined size is stored as an updated region by the value of a bit (0/1). In the present embodiment, the initial values of the bits of the bit map are made “0” and the value of the bit when designating a region including a location where data was updated as an updated region is made “1”.

That is, a bit map managing each 8 kbyte region by 1 bit deems all of the 8 kbyte region as an updated region if even part of the 8 kbytes covered has been updated. A bit map managing each 8 kbyte region by 1 bit can manage a 300 Gbyte region by about 4.7 Mbytes.

If there is data to be updated in the disk B when the disk B is separated, it is written in the disk A2 and the bit corresponding the updated region on the bit map are made “1”. Next, the region with the updated data (in the present example, 8 kbytes) is copied from the disk A2 to the spare disk C for rebuilding.

After the disk B is assembled into the disk array apparatus in place of the disk A1, the bit map is referred to and the regions where the values of the bits are “1”, that is, the parts where the data was updated, are copied from the disk A2 to the disk B. The bits are set to “0” for the regions finished being copied. When all updated regions have finished being processed, the bit map management ends and the RAID1 is reconfigured (FIG. 4(c)). As a result, the disk B ends up having exactly the same data as the disk A2.

If it takes for example 1 minute from when the disk B is pulled out to when it is reinserted, since it is sufficient to copy only the updated parts during this time, that is, the difference, the processing time can be greatly shortened compared with the past when copying all of the data of the disk B in a new disk A1′.

Here, when processing for writing or reading data to or from the disk A2 or B becomes necessary before the disk B is inserted and all of the updated regions are copied to the disk B, the following is performed:

(1) For writing of data into a region where the value of the bit on the bit map is “0” (region not updated when disk B is separated), the data is written into both the disks A2 and B and the bit is left as “0”.

(2) For writing of data into a region where the value of the bit is “1” (region updated when disk B is separated and not yet copied back to disk B), first the updated data is written in the disk A2, then the data of the 8 kbytes of the updated region is copied to the disk B and the bit is set to “0”.

(3) For reading of data, data is read from the disk A2 regardless of whether the value of that region on the bit map is “0” or “1”. Since the data is read without judging the value of the bit of the read region, high speed reading becomes possible.

The spare disk C is used in preparation for a failure in the disk A2. While the disk B is separated from the disk array apparatus and assembled at the position where the disk A1 had been, any updated region including updated data is written. When the disk B is separated from the disk array apparatus, as explained above, bit map management is actuated, the data to be updated is written into the disk A2, and simultaneously the bit map stores the updated regions including updated data. After that, the updated regions are copied onto the disk C utilizing the disk A2 and the bit map. If the disk A2 fails and cannot be used after the disk B is assembled into the disk array apparatus, the updated regions are copied from the disk C to the disk B while referring to the bit map. By doing this, the reliability can be further enhanced.

If processing for writing or reading data to or from the disk A2 or B becomes necessary while copying updated regions to the disk B using the disk C, the following is performed:

(1) For writing of data to a region of the bit 0 on the bit map, the data is written in only the disk B. The bit is left as “0”.

(2) For writing of data to a region of the bit 1 on the bit map, first the data is written in the disk C, the data of the 8 kbytes of the region concerned is copied to the disk B by rebuilding, and the bit is set to “0”.

(3) For reading of data from a region of the bit 0, the data is read from the disk B, while for reading of data from a region of the bit 1, the data is read from the disk C.

Finally, as shown in FIG. 4(d), a new disk D is inserted at the original position of the disk B for use as a spare disk. Note that the new disk D can be inserted as a spare disk in parallel without waiting for completion of the copyback processing to the disk B. By doing this, the disks B and A2 are paired and a RAID1 configuration like before is returned to.

FIG. 5 schematically shows a second embodiment applying the present invention to the RAID5. The disks A1, A2, and A3 form the RAID5. B and C are provided as hot spares.

In the RAID5, striping is performed for the disks A1, A2, and A3, so the data and parity data are stored dispersed.

If the disk A1 fails, the data of the disk A1 is reconfigured from the disk A2 and disk A3 and rebuilt at the spare disk B (FIG. 5(a)).

Next, the disk B is separated from the disk array apparatus at the instruction of the maintenance terminal 40. Simultaneously, bit map management is started and another hot spare disk C starts to be used. The initial values of the bits of the bit map are set at “0”. A bit for a region updated in data is set at “1”. As explained above, if the region managed by 1 bit of the bit map is 8 kbytes, the entire 8 kbyte region is deemed an updated region if even part of the 8 kbytes covered is updated.

If there is data to be updated when the disk B is separated, it is written in the disks A2 and A3 and the corresponding bits on the bit map are set to “1”. Next, the 8 kbytes of each updated region are rebuilt at the spare disk C utilizing the parity data from the disks A2 and A3.

When the disk B is inserted at the position of A1 and is in a state able to be used, data of regions of the bit “1” on the bit map are rebuilt from the disks A2 and A3 to the disk BZ. The bit map values of the regions finished being rebuilt are set to “0”.

When there is a request for writing or reading data to or from the disk array when the disk B replaces the disk A1 and during the rebuilding of the updated regions from the disks A2 and A3 to the disk B, the following is performed:

(1) For writing of data to a region of the bit “0” on the bit map (region not updated when the disk B is separated), the data is written in all of the disks A2, A3 and the disk B. The bit is left at “0” and is not changed.

(2) For writing of data at a region of the bit “1” on the bit map (region updated when the disk B is separated and not yet rebuilt on the disk B), first the data is written in the disks A2 and A3. When the data finishes being written, the region concerned (8 kbytes) is rebuilt on the disk B. When the rebuilding finishes, the bit is set to “0”.

(3) For the reading of data, the data is read from the disks A2 and A3 without regard as to the values of the bits of the bit map.

After all the updated regions finish being processed, the bit map management ends and the RAID5 is reconfigured by the disk B1 inserted into the position of the disk A1 and by the disks A2 and A3. Note that the disk C returns to a hot spare.

Next, if after the disk B is assembled into the disk array apparatus, the disk A2 or the disk A3 fails and cannot be used, the disk C can be utilized. That is, any updated region to be written in the disk B is rebuilt in the disk C, so can be copied from the disk C to the disk B by referring to the bit map. In this way, it is possible to further raise the reliability of the RAID.

For example, when the disk A2 fails and processing for writing or reading data to or from the disks A2, A3, or B becomes necessary before the disk B is connected to the disk array apparatus and the updated regions finish being rebuilt utilizing the disk C, the following is performed.

(1) For writing of data into a region of the bit “0” on the bit map, the data is written into both the disk A3 and the disk B. The bit is left as “0”.

(2) For writing of data into a region of the bit “1” on the bit map, first the data is written into the disk A3 and the disk C. After it finishes being written, the region concerned (8 kbytes) is rebuilt in the disk B. When finished being rebuilt, the bit is set to “0”.

(3) For reading of data from a region of the bit “0” on the bit map, the data is read from the disk A3 and the disk B.

(4) For reading of data from a region of the bit “1” on the bit map, the data is read from the disk A3 and the disk C.

Finally, the new disk D is inserted into the location where the disk B had originally been and is used as the spare disk D. Note that only naturally, after the disk B is separated, it is possible to insert the new disk D without waiting for completion of rebuilding of data at the disk B.

Above, as embodiments, the RAID1 and the RAID5 were explained, but the present invention can of course be applied to the other levels of RAIDs as well.

While the invention has been described with reference to specific embodiments chosen for purpose of illustration, it should be apparent that numerous modifications could be made thereto by those skilled in the art without departing from the basic concept and scope of the invention.

1. A method for restoring a disk array apparatus from failure of a disk, comprising:
rebuilding data from another disk at a first spare disk,
separating said rebuilt first spare disk from said disk array apparatus,
writing the data to be updated in said separated first spare disk into said other disk until said separated first spare disk is connected with said disk array apparatus and storing the disk regions of said data to be updated into a bit map, and
connecting said rebuilt first spare disk to said disk array apparatus at the position of arrangement of said failed disk.

2. A method as set forth in claim 1, further comprising, after connecting said first spare disk to said disk array apparatus, rebuilding said updated data from said other disk on said first spare disk by referring to said bit map.

3. A method as set forth in claim 1, further comprising, after writing said data to be updated in said other disk and storing the regions of said data to be updated into a bit map, rebuilding the updated data written in said other disk on a second spare disk.

4. A method as set forth in claim 1, further comprising, when said other disk fails, connecting said first spare disk to said disk array apparatus, then rebuilding said updated data from said second spare disk on said first spare disk by referring to said bit map.

5. A disk array apparatus, comprising:
a redundant disk array,
a first spare disk storing rebuilt data of a failed disk in said redundant disk array using data of another disk, and
a bit map storing a region of said first spare disk in which data is to be updated in said first spare disk when a first spare disk is detached from the apparatus.

6. A disk array apparatus as set forth in claim 5, wherein the data to be updated in the first spare disk is written into the other disk when the first spare disk is detached from the apparatus.

7. A disk array apparatus as set forth in claim 6, further comprising a second spare disk for rebuilding regions including data to be updated in said first spare disk when said first spare disk is detached from the apparatus.
